(19) United States
(12) Patent Application Publication
(10) Pub. No.: US 2016/0364147 A1
(43) Pub. Date: Dec. 15, 2016

(54) EXECUTION HARDWARE FOR LOAD AND STORE OPERATION ALIGNMENT

(71) Applicant: QUALCOMM Incorporated, San Diego, CA (US)

(72) Inventor: Eric Wayne Mahurin, Austin, TX (US)

(21) Appl. No.: 14/738,631

(22) Filed: Jun. 12, 2015

(51) Int. Cl. G06F 3/06; G06F 12/08

(52) U.S. Cl. CPC G06F 3/0604; G06F 3/0638; G06F 3/0683; G06F 12/0895; G06F 2212/60

(57) ABSTRACT

An apparatus includes an execution unit configured to modify register aligned data having a first portion of a vector of data and a second portion of the vector of data to generate modified data. The vector of data is stored in a register file prior to modification. The execution unit is further configured to generate first data and second data based on the modified data. The first data includes the first portion of the vector of data, and the second data includes the second portion of the vector of data. A memory unit is operable to store the first data at a first portion of the memory unit and to store the second data at a second portion of the memory unit. The register aligned data is unaligned with respect to the first portion of the memory unit and unaligned with respect to the second portion of the memory unit.

### I. FIELD

The present disclosure is generally related to load and store operation alignment. More specifically, the present disclosure is related to aligning data for load operations and store operations using hardware components in an execution unit.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Wireless telephones and other electronic devices may include a single-instruction-multiple-data (SIMD) processor that loads a vector of data into a memory location (e.g., a register file) and stores a vector of data into another memory location (e.g., a cache or a main memory). In certain instances, a SIMD processor may attempt to load/store a vector of data in a memory location having a size that is different from the size of the vector of data. Thus, in this case, the vector of data and the memory location may be unaligned. Using software (e.g., additional instructions) to align the vector of data with the memory location prior to loading/storing the vector of data into the memory location may increase the overhead and latency of the SIMD processor. Using a memory subsystem (e.g., a cache/memory unit) to align the vector of data with the memory location prior to loading/storing the vector of data into the memory location may require additional alignment hardware and may add complexity to the memory subsystem.

### III. SUMMARY

Techniques and methods to align a vector of data for a load operation and a store operation are disclosed. A processing architecture (e.g., a memory subsystem and an execution unit) supports execution of an instruction to load a vector of data stored at an unaligned address at a cache (or a memory) into a destination register. The vector of data stored at the unaligned address of the cache (or the memory) may occupy two cache lines (e.g., two 64-byte cache lines) and the load instruction may be broken (e.g., decomposed) into two transactions. For example, the address of the first cache line may be included in a first transaction that retrieves a first portion of the vector of data and the address of the second cache line may be included in a second transaction that retrieves a second portion of the vector of data. The first transaction and the second transaction may be provided to the cache (or the memory) by the instruction from the processing architecture.

The cache may access first data associated with the first cache line and second data associated with the second cache line upon receiving the first transaction and the second transaction, respectively. The first data may include the first portion of the vector of data and the second data may include the second portion of the vector of data. Merge hardware in the execution unit may merge the first portion of the vector of data with the second portion of the vector of data to generate merged data. Rotation hardware in the execution unit may rotate the merged data (e.g., the first portion of the vector of data and the second portion of the vector of data) to generate rotated data. The rotated data may be stored in the destination register.

In a particular aspect, an apparatus includes a cache storing a first portion of a vector of data in a first cache line and a second portion of the vector of data in a second cache line. The vector of data corresponds to an unaligned memory address (e.g., an address that includes more than one cache line). The apparatus includes an execution unit configured to merge the first portion of the vector of data and the second portion of the vector of data to generate merged data. The execution unit is further configured to rotate the merged data to generate rotated data that is aligned with the register file. The execution unit is also configured to store the rotated data in the register file. The register file may include a destination register.

In another particular aspect, a method includes merging, at an execution unit, a first portion of a vector of data and a second portion of the vector of data to generate merged data. The first portion of the vector of data is stored in a first cache line of a cache and the second portion of the vector of data is stored in a second cache line of the cache. The vector of data corresponds to an unaligned memory address (e.g., an address that includes more than one cache line). The method also includes rotating the merged data to generate rotated data that is aligned with the register file. The method further includes storing the rotated data in the register file. The register file may include a destination register.

In another particular aspect, a non-transitory computer-readable medium includes instructions that, when executed by an execution unit within a processor, cause the execution unit to merge a first portion of a vector of data and a second portion of the vector of data to generate merged data. The first portion of the vector of data is stored in a first cache line of a cache and the second portion of the vector of data is stored in a second cache line of the cache. The vector of data corresponds to an unaligned memory address (e.g., an address that includes more than one cache line). The instructions are also executable to cause the execution unit to rotate the merged data to generate rotated data that is aligned with the register file. The instructions are further executable to cause the execution unit to store the rotated data in the register file. The register file may include a destination register.

In another particular aspect, an apparatus includes means for merging a first portion of a vector of data and a second portion of the vector of data to generate merged data. The first portion of the vector of data is stored in a first cache line of a cache and the second portion of the vector of data is stored in a second cache line of the cache. The vector of data corresponds to an unaligned memory address (e.g., an address that includes more than one cache line). The apparatus also includes means for rotating the merged data to generate rotated data. The apparatus further includes means for storing the rotated data. The rotated data may be aligned with the means for storing the rotated data. The means for storing the rotated data may be a register file.

In another particular aspect, a method includes modifying (e.g., rotating or shifting), at an execution unit, register aligned data having a first portion of a vector of data and a second portion of the vector of data to generate modified data. The vector of data is stored in a register file prior to modification. The method also includes generating first data and second data based on the modified data by separating the register aligned data. The first data includes the first portion of the vector of data, and the second data includes the second portion of the vector of data. The method further includes storing the first data at a first portion of a memory unit and storing the second data at a second portion of the memory unit. The register aligned data is unaligned with respect to the first portion of the memory unit and unaligned with respect to the second portion of the memory unit.

In another particular aspect, an apparatus includes an execution unit configured to modify (e.g., rotate or shift) register aligned data having a first portion of a vector of data and a second portion of the vector of data to generate modified data. The vector of data is stored in a register file prior to modification. The execution unit is further configured to generate first data and second data based on the modified data by separating the register aligned data. The first data includes the first portion of the vector of data, and the second data includes the second portion of the vector of data. The apparatus also includes a memory unit that is operable to store the first data at a first portion of the memory unit and to store the second data at a second portion of the memory unit. The register aligned data is unaligned with respect to the first portion of the memory unit and unaligned with respect to the second portion of the memory unit.

In another particular aspect, a non-transitory computer-readable medium includes instructions that, when executed by an execution unit within a processor, cause the execution unit to modify (e.g., rotate or shift) register aligned data having a first portion of a vector of data and a second portion of the vector of data to generate modified data. The vector of data is stored in a register file prior to modification. The instructions are also executable to cause the execution unit to generate first data and second data based on the modified data by separating the register aligned data. The first data includes the first portion of the vector of data, and the second data includes the second portion of the vector of data. The instructions are further executable to cause the execution unit to store the first data at a first portion of a memory unit and to store the second data at a second portion of the memory unit. The register aligned data is unaligned with respect to the first portion of the memory unit and unaligned with respect to the second portion of the memory unit.

In another particular aspect, an apparatus includes means for modifying register aligned data having a first portion of a vector of data and a second portion of a vector of data to generate modified data. The vector of data is stored in a register file prior to rotation. The apparatus also includes means for generating first data and second data based on the modified data. The first data includes the first portion of the vector of data, and the second data includes the second portion of the vector of data. The apparatus further includes means for storing the first data and the second data.

One particular advantage provided by at least one of the disclosed embodiments is an ability to align data using existing hardware in an execution unit. For example, merge/rotate hardware in the execution unit may align data to reduce latency and overhead (compared to using software) and to reduce cost and complexity (compared to adding alignment hardware in a memory subsystem). Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 includes a diagram of an illustrative embodiment of a system that is operable to use execution hardware to align a vector of data for a store operation;

FIG. 2 includes a diagram of an illustrative embodiment of a system that is operable to use execution hardware to align a vector of data for a load operation;

FIG. 3 is a flowchart of a particular embodiment of a method for aligning a vector of data for a store operation using execution hardware;

FIG. 4 is a flowchart of a particular embodiment of a method for aligning a vector of data for a load operation using execution hardware; and

FIG. 5 is a block diagram of a wireless device including execution hardware that is operable to align a vector of data for a load operation and/or a store operation.

### V. DETAILED DESCRIPTION

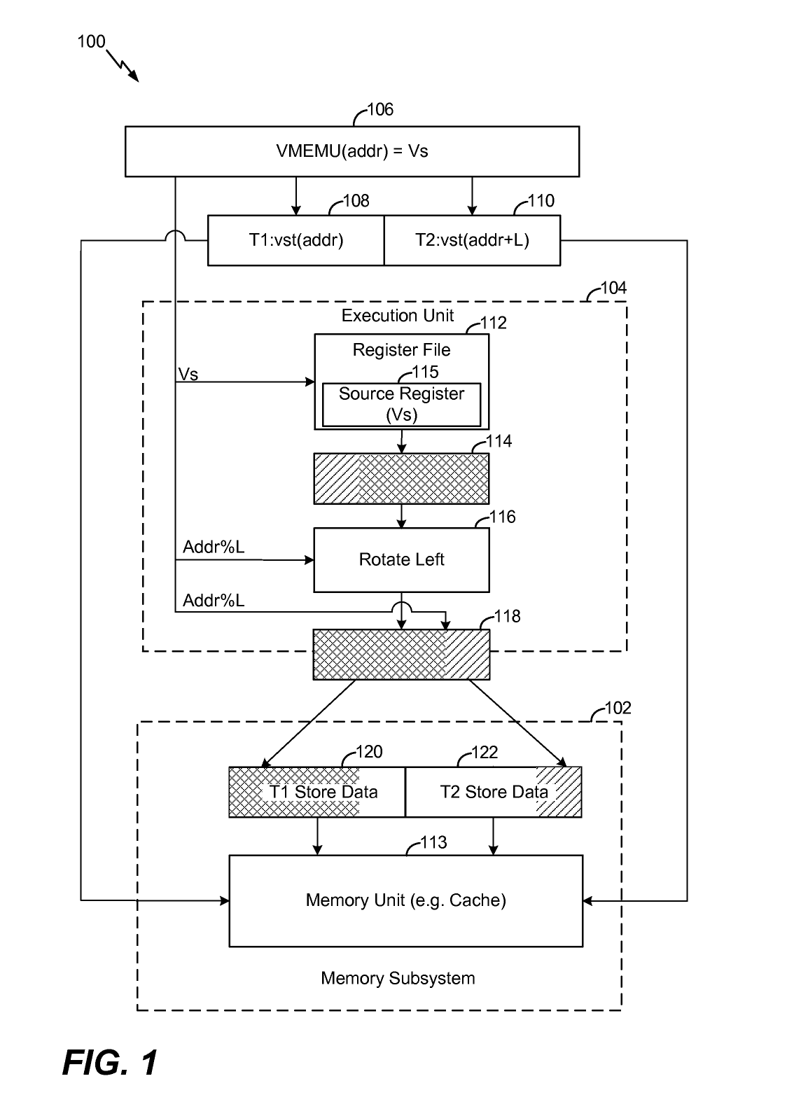

Referring to FIG. 1, a particular embodiment of a system 100 that is operable to use execution hardware to align a vector of data for a store operation is shown. The system 100 includes a memory subsystem 102 and an execution unit 104. In a particular embodiment, the components of the system 100 may be implemented in a wireless device (e.g., a mobile phone or a tablet computer). Alternatively, the system 100 may be integrated into a set top box, a music player, a video player, an entertainment unit, a navigation device, a PDA, a fixed location data unit, or a computer.

An instruction 106 to store a vector of data may be provided to the execution unit 104. The instruction 106 (e.g., VMEMU(addr)=Vs) may specify an unaligned address (addr) in a memory unit 113 (e.g., a cache) to store a vector of data in a source register (Vs) 115. The source register 115 is located in a register file 112 of the execution unit 104. As used herein, a vector of data having an unaligned address corresponds to a vector of data that has a first portion of data in a first portion of the memory unit 113 (e.g., a first 64-byte cache line or a “first cache line”) in the memory subsystem 102 and a second portion of data in a second portion of the memory unit 113 (e.g., a second 64-byte cache line or a “second cache line”). An address of the first portion of the memory unit 113 may be adjacent to an address of the second portion of the memory unit 113.

A size of the source register 115 may be equal to, less than, or greater than a size of a cache line in the memory unit 113. According to one implementation, the size of the source register 115 may be equal to the size of a cache line in the memory unit 113. For example, the size of the source register 115 may be equal to the size of a first portion of the memory unit 113 and equal to a size of the second portion of the memory unit 113. According to another implementation, the size of the source register 115 may be less than a size of a cache line in the memory unit 113. For example, the size of the source register 115 may be smaller than the size of the first portion of the memory unit 113 and smaller than the size of the second portion of the memory unit 113. According to another implementation, the size of the source register 115 may be greater than a size of a cache line in the memory unit 113. For example, the size of the source register 115 may be greater than the size of the first portion of the memory unit 113 and greater than the size of the second portion of the memory unit 113.

In the illustrated embodiment, “addr” may correspond to the starting address (e.g., the location of the most significant bit) in the memory unit 113 of a location where the vector of data is to be stored. In a particular aspect, the most significant bit may be the “right-most” bit such that the address of the vector of data is read from right to left. As a non-limiting example, the vector of data may have a length (L) of 64-bytes (e.g., a 64-byte vector of data) and the source register 115 may be a 64-byte vector register. A first portion of the vector of data (illustrated by cross shading) may be a 58-byte portion of the vector of data. A second portion of the vector of data (illustrated by diagonal line shading) may be a 6-byte portion of the vector of data. The instruction 106 may cause the execution unit 104 to store the first portion of the vector of data in a first cache line of the memory unit 113 and to store the second portion of the vector of data in a second cache line of the memory unit 113.

In response to receiving the instruction 106, the execution unit 104 may provide the vector of data (e.g., register aligned data) from the register file 112 to a temporary storage 114. When a rotation unit (Rotate Left) 116 of the execution unit 104 is available, the execution unit 104 may provide the vector of data from the temporary storage 114 to the rotation unit 116. The rotation unit 116 may be configured to rotate the vector of data. For example, the rotation unit 116 may rotate the first portion of the vector of data and the second portion of the vector of data such that the data associated with the starting address (addr) (e.g., the most significant bit) is on the left and data associated with the ending address (addr+L) (e.g., the least significant bit) is on the right. To illustrate, information associated with the instruction 106 (e.g., the starting address (addr) and the vector length (L)) may be provided to the rotation unit 116. Based on the starting address modulus vector length (Addr % L), the rotation unit 116 may determine a location to rotate the vector of data to generate rotated data. Thus, the vector of data (e.g., the register aligned data) may be rotated based on a vector offset specified in “lower bits” of an unaligned store address. The rotated data may be provided to a separation unit 118.

The separation unit 118 may be configured to separate a first portion of the rotated data (e.g., the first portion of the vector of data) and a second portion of the rotated data (e.g., the second portion of the vector of data) to generate first data (T1 Store Data) 120 and second data (T2 Store Data) 122, respectively. For example, based on information associated with the instruction 106 (e.g., the starting address (addr) and the vector length (L)), the separation unit 118 may be configured to insert the first portion of the rotated data in the first data (T1 Store Data) 120 and to insert the second portion of the rotated data in the second data (T2 Store Data) 122. The first data 120 may be a 64-byte vector of data (e.g., a cache aligned vector of data), and the second data 122 may be a 64-byte vector of data (e.g., a cache aligned vector of data).

In response to receiving the instruction 106, the memory subsystem 102 (or an external processor) may generate two transactions 108, 110 based on the starting address in the memory unit 113 of a location where the vector of data (in the register file 112) is to be stored. For example, the memory subsystem 102 may break (e.g., “decompose”) an unaligned store instruction into a first transaction (T1:vsnaddr)) 108 and a second transaction (T2:vst(addr+L)) 110. The first transaction 108 may be a first aligned cache transaction, and the second transaction 110 may be a second aligned cache transaction. For example, the first transaction 108 may identify a 64-byte cache line (e.g., a first cache line) that includes the starting address (addr), and the second transaction 110 may identify a 64-byte cache line (e.g., a second cache line) that includes the ending address (addr+L). Based on the transactions 108, 110, the memory subsystem 102 may store the first data 120 in the first portion of the memory unit 113 (e.g., the first cache line) and may store the second data 122 in the second portion of the memory unit 113 (e.g., the second cache line).

In a particular aspect, the vector of data is rotated in response to an unaligned offset between the vector of data and the first data 122 (or between the vector of data and the second data 122) being greater than zero. Otherwise (e.g., if the unaligned offset is equal to zero and there is no rotation), one of the transactions 108, 110 is a 0-byte transaction.

The system 100 of FIG. 1 may use existing hardware in the execution unit 104 to store the register aligned vector of data in the register file 112 into an unaligned address in the memory unit 113. For example, the system 100 may use the rotation unit 116 and the separation unit 118 to align the vector of data in the register file 112 into two cache lines of the memory unit 113. Because most processor execution units include rotate/separation hardware, the techniques described with respect to FIG. 1 may use the rotate/separation hardware (e.g., the rotation unit 116 and the separation unit 118) to reduce latency and overhead (compared to using software) in the SIMD processor and to reduce cost and complexity (compared to adding additional hardware to align a vector of data with the memory unit 113 in the memory subsystem 102) of aligning the vector of data for a load operation and a store operation in the SIMD processor.

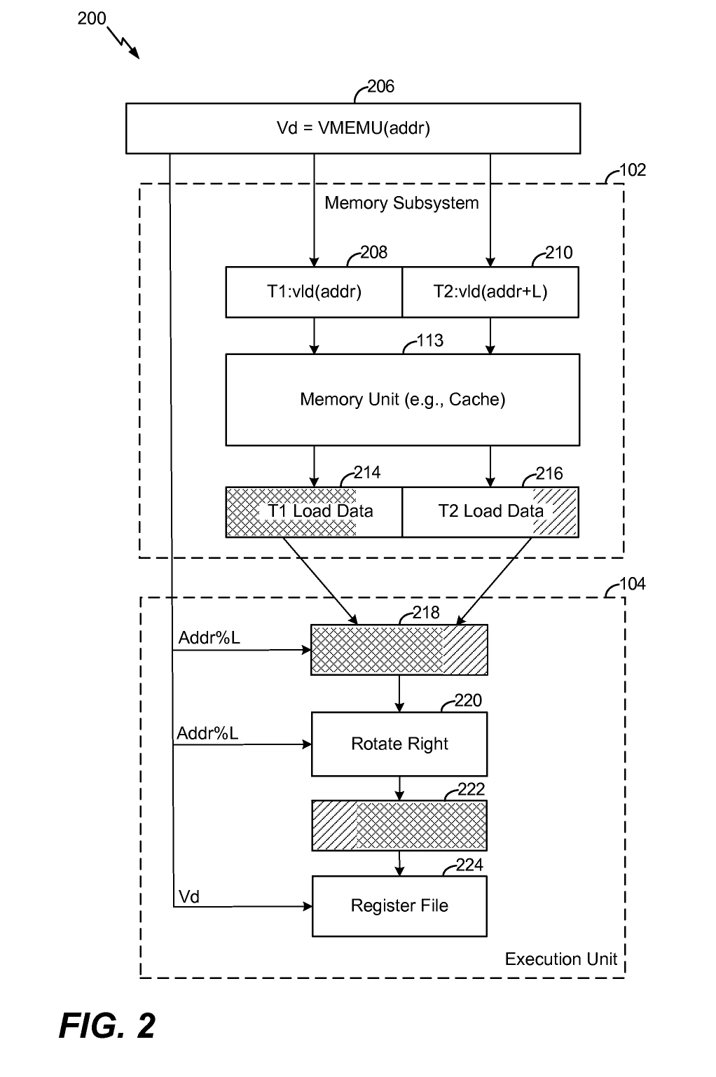

Referring to FIG. 2, a particular embodiment of a system 200 that is operable to use execution hardware to align a vector of data for a load operation is shown. The system 200 includes the memory subsystem 102 and the execution unit 104. In a particular embodiment, the components of the system 100 may be implemented in a wireless device (e.g., a mobile phone). Alternatively, the system 100 may be integrated into a set top box, a music player, a video player, an entertainment unit, a navigation device, a PDA, a fixed location data unit, or a computer.

An instruction 206 to load a vector of data may be provided to the memory subsystem 102. The instruction 206 (e.g., Vd=VMENU(addr)) may specify a destination register (Vd) (e.g., a register file 224) in the execution unit 104 to load a vector of data having an unaligned address (addr). For example, “addr” may correspond to the starting address (e.g., the location of the most significant bit) of the vector of data. In a particular aspect, the most significant bit may be the “right-most” bit such that the address of the vector of data is read from right to left.

As used herein, a vector of data having an unaligned address corresponds to a vector of data that has a portion in a first cache line (e.g., a 64-byte cache line) of the memory unit 113 (or main memory) in the memory subsystem 102 and a second portion in a second cache line (e.g., a 64-byte cache line) of the memory unit 113. As an illustrative non-limiting example, the vector of data may have a length (L) of 64-bytes (e.g., a 64-byte vector of data) and the register file 224 may be a 64-byte register file. A first portion of the vector of data (e.g., a 58-byte portion of the vector of data) may be located in the first cache line of the memory unit 113, and a second portion of the vector of data (e.g., a 6-byte portion of the vector of data) may be located in the second cache line of the memory unit 113. Thus, the vector of data is “unaligned” with a single cache line of the memory unit 113.

In response to receiving the instruction 206, the memory subsystem 102 may generate two transactions 208, 210 based on the location of the vector of data. For example, the memory subsystem 102 may break (e.g., “decompose”) the unaligned load into a first transaction (T1:v1d(addr)) 208 and a second transaction (T2:v1d(addr+L)) 210. The first transaction 208 may be a first aligned cache access transaction, and the second transaction 210 may be a second aligned cache access transaction. For example, the first transaction 208 may identify a 64-byte cache line (e.g., the first cache line) that includes the first portion of the vector of data (e.g., the 58-byte portion of the vector of data), and the second transaction 210 may identify a 64-byte cache line (e.g., the second cache line) that includes the second portion of the vector of data (e.g., the 6-byte portion of the vector of data). The first transaction 208 may identify the starting address (addr) (e.g., the location of the most significant bit) of the vector of data identified in the instruction 206, and the second transaction 210 may identify the ending address (addr+L) (e.g., the location of the least significant bit) of the vector of data identified in the instruction 206.

The first transaction 208 and the second transaction 210 may be provided to the memory unit 113. The memory system 102 may determine whether each transaction 208, 210 corresponds to a “cache hit” or a “cache miss”. For example, the memory system 102 may determine whether the first cache line associated with the first transaction 208 and the second cache line associated with the second transaction 210 are located in the memory unit 113. If the first cache line storing the first portion of the vector of data is not located in the memory unit 113 (e.g., a cache miss), the memory system 102 may be configured to retrieve the first cache line (including the first portion of the vector of data) from a main memory (not shown) and to store the first cache line in the memory unit 113. In a similar manner, if the second cache line storing the second portion of data in not located in the memory unit 113, the memory system 102 may be configured to retrieve the second cache line (including the second portion of the vector of data) from the main memory and to store the second cache line in the memory unit 113.

When the first cache line associated with the first transaction 208 and the second cache line associated with the second transaction 210 are in the memory unit 113 (e.g., a cache hit), the memory system 102 may access first data (T1 Load Data) 214 associated with the first cache line and second data (T2 Load Data) 216 associated with the second cache line. The first data 214 may include the first portion of the vector of data (illustrated by cross shading) and the second data 216 may include the second portion of the vector of data (illustrated by diagonal line shading).

The execution unit 104 may include a merge unit 218 that is configured to merge a portion of the first data 214 (e.g., the first portion of the vector of data) and a portion of the second data 216 (e.g., the second portion of the vector of data) to generate merged data. For example, based on information associated with the instruction 206 (e.g., the starting address (addr) and the vector length (L)), the merge unit 218 may be configured to extract the first portion of the vector of data from the first data 214, to extract the second portion of the vector of data from the second data 216, and to merge the first portion of the vector of data and the second portion of the vector of data to generate merged data. To illustrate, the starting address modulus vector length (Addr % L) may be provided to the merge unit 218. Based on the starting address modulus vector length (Addr % L), the merge unit 218 may determine a location of the first data 214 to begin extraction (e.g., a location associated with the starting address (addr)) and a location of the second data 216 to end extraction (e.g., a location associated with the ending address (addr+L)). The merged data may be provided to a rotation unit (Rotate Right) 220 of the execution unit 104.

The rotation unit 220 may be configured to rotate the merged data to generate rotated data. For example, the rotation unit 220 may rotate the first portion of the vector of data and the second portion of the vector of data such that data associated with the starting address (addr) (e.g., the most significant bit) is on the right and data associated with the ending address (addr+L) (e.g., the least significant bit) is on the left. To illustrate, information associated with the instruction 206 (e.g., the starting address (addr) and the vector length (L)) may be provided to the rotation unit 220. Based on the starting address modulus vector length (Addr % L), the rotation unit 220 may determine a location to rotate the merged data to generate the rotated data (e.g., aligned data). The rotated data may be stored in a temporary storage 222 and provided to the register file 224 (e.g., the destination register (Vd)).

The system 200 of FIG. 2 may use existing hardware in the execution unit 104 to align the vector of data with the register file 224. For example, the system 200 may use the merge unit 218 and the rotation unit 220 to align the vector of data with the register file 224. Because most processor execution units include merge/rotate hardware, the techniques described with respect to FIG. 2 may use the merge/rotate hardware (e.g., the merge unit 218 and the rotation unit 220) to reduce latency and overhead (compared to using software) and to reduce cost and complexity (compared to adding alignment hardware in the memory subsystem 102).

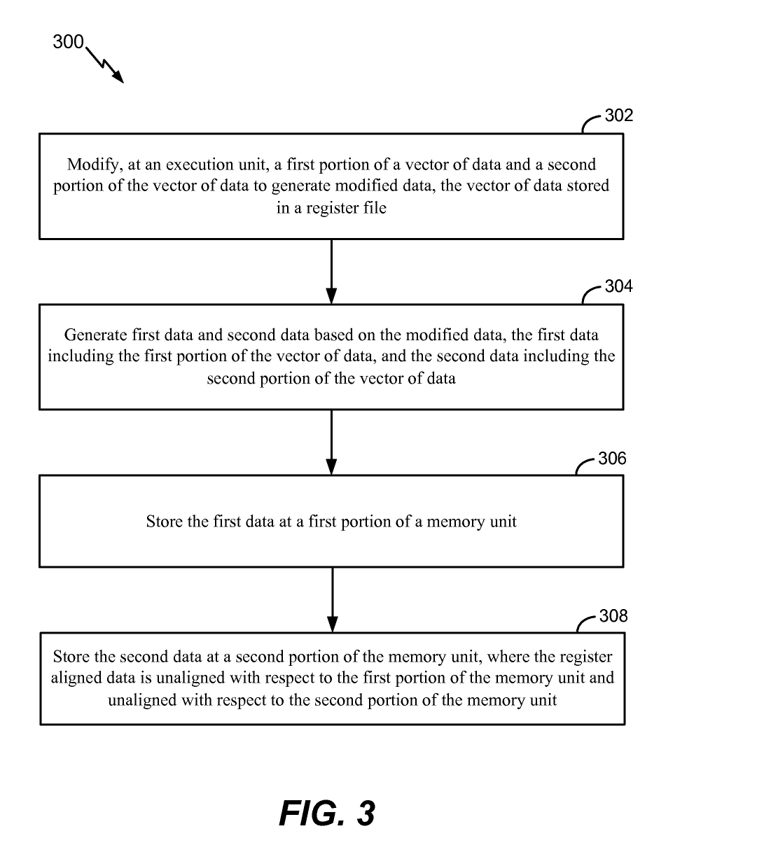

Referring to FIG. 3, a flowchart of a particular embodiment of a method 300 for aligning a vector of data for a store operation using execution hardware is shown. The method 300 may be performed using the system 100 of FIG. 1.

The method 300 includes modifying, at an execution unit, a first portion of a vector of data and a second portion of the vector of data to generate modified data, at 302. For example, referring to FIG. 1, the rotation unit 116 may rotate the first portion of the vector of data and the second portion of the vector of data such that the data associated with the starting address (addr) (e.g., the most significant bit) is on the left and data associated with the ending address (addr+L) (e.g., the least significant bit) is on the right. To illustrate, information associated with the instruction 106 (e.g., the starting address (addr) and the vector length (L)) may be provided to the rotation unit 116. Based on the starting address modulus vector length (Addr % L), the rotation unit 116 may determine a location to rotate the vector of data to generate rotated data. The vector of data may be stored in the register file 112 (e.g., stored in the source register 115). It should be understood that rotating the first portion of the vector data and the second portion of vector of data is merely an example of modification. According to other implementations a shift left operation or a shift right operation may be performed to modify the first portion of the vector data and the second portion of vector of data.

First data and second data may be generated based on the modified data, at 304. For example, referring to FIG. 1, the separation unit 118 may separate a first portion of the rotated data (e.g., the first portion of the vector of data) and a second portion of the rotated data (e.g., the second portion of the vector of data) to generate first data (T1 Store Data) 120 and second data (T2 Store Data) 122, respectively. For example, based on information associated with the instruction 106 (e.g., the starting address (addr) and the vector length (L)), the separation unit 118 may insert the first portion of the rotated data in the first data 120 and to insert the second portion of the rotated data in the second data 122. The first data 120 may be a 64-byte vector of data (e.g., a cache aligned vector of data), and the second data 122 may be a 64-byte vector of data (e.g., a cache aligned vector of data).

The first data may be stored at a first portion of a memory unit, at 306. For example, referring to FIG. 1, the memory subsystem 102 may store the first data 120 in the first cache line of the memory unit 113 based on the first transaction 108. The second data may be stored at a second portion of the memory unit, at 308. The register aligned data may be unaligned with respect to the first portion of the memory unit and unaligned with respect to the second portion of the memory unit. For example, referring to FIG. 1, the memory subsystem 102 may store second data 122 in the second cache line of the memory unit 113 based on the second transaction 110.

The method 300 of FIG. 3 may use existing hardware in the execution unit 104 to store the vector aligned vector of data in the register file 112 into an unaligned address in the memory unit 113. For example, the system 100 may use the rotation unit 116 and the separation unit 118 to align the vector of data in the register file 112 into the two cache lines of the memory unit 113. Because most processor execution units include rotate/separation hardware, the method 300 may use the rotate/separation hardware (e.g., the rotation unit 116 and the separation unit 118) to reduce latency and overhead (compared to using software) and to reduce cost and complexity (compared to adding alignment hardware in the memory subsystem 102).

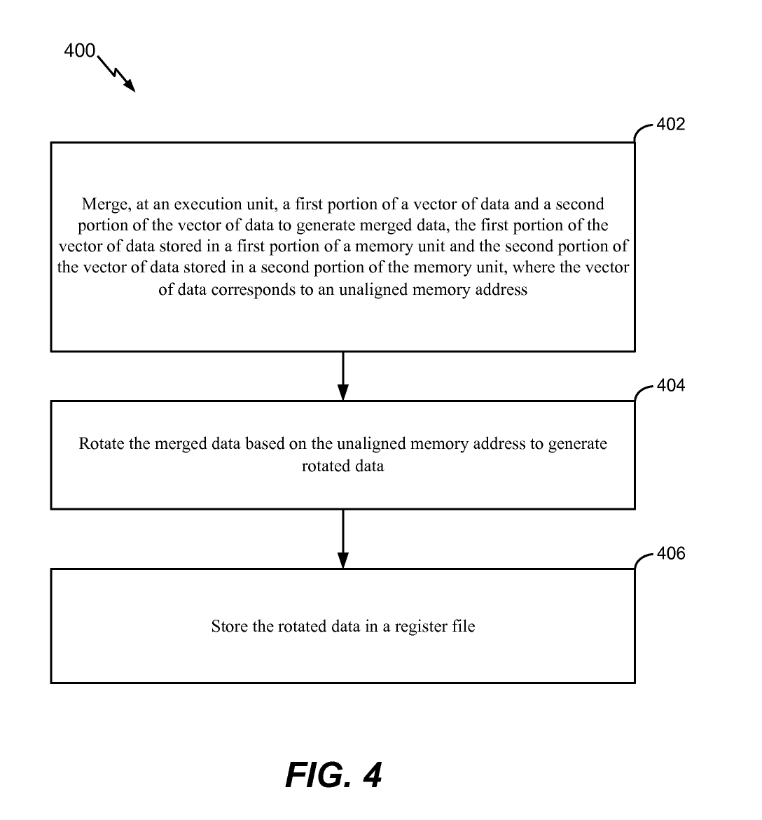

Referring to FIG. 4, a flowchart of a particular embodiment of a method 400 for aligning a vector of data for a load operation using execution hardware is shown. The method 400 may be performed using the system 200 of FIG. 2.

The method 400 includes merging, at an execution unit, a first portion of a vector of data and a second portion of the vector of data to generate merged data, at 402. For example, referring to FIG. 2, the merge unit 218 may merge a portion of the first data 214 (e.g., the first portion of the vector of data) and a portion of the second data 216 (e.g., the second portion of the vector of data) to generate merged data. The first portion of the vector data may be stored in the first cache line of the memory unit 113, the second portion of the vector of data may be stored in the second cache line of the memory unit 113, and the vector of data may correspond to an unaligned memory address. Based on information associated with the instruction 206 (e.g., the starting address (addr) and the vector length (L)), the merge unit 218 may extract the first portion of the vector of data from the first data 214, extract the second portion of the vector of data from the second data 216, and merge the first portion of the vector of data and the second portion of the vector of data to generate merged data. To illustrate, the starting address modulus vector length (Addr % L) may be provided to the merge unit 218. Based on the starting address modulus vector length (Addr % L), the merge unit 218 may determine a location of the first data 214 to begin extraction (e.g., a location associated with the starting address (addr)) and a location of the second data 216 to end extraction (e.g., a location associated with the ending address (addr+L)).

The merged data may be rotated based on the unaligned memory address to generate rotated data, at 404. For example, referring to FIG. 2, the merged data may be provided to the rotation unit (Rotate Right) 220 of the execution unit 104. The rotation unit 220 may rotate the merged data to generate rotated data. For example, the rotation unit 220 may rotate the first portion of the vector of data and the second portion of the vector of data such that data associated with the starting address (addr) (e.g., the most significant bit) is on the right and data associated with the ending address (addr+L) (e.g., the least significant bit) is on the left. To illustrate, information associated with the instruction 206 (e.g., the starting address (addr) and the vector length (L)) may be provided to the rotation unit 220. Based on the starting address modulus vector length (Addr % L), the rotation unit 220 may determine a location to rotate the merged data to generate the rotated data (e.g., aligned data).

The rotated data may be stored in a register file, at 406. For example, referring to FIG. 2, the rotated data may be stored in a temporary storage 222 and provided to the register file 224 (e.g., the destination register (Vd)).

The method 400 of FIG. 4 may use existing hardware in the execution unit 104 to align the vector of data with the register file 224. For example, the method 400 may use the merge unit 218 and the rotation unit 220 to align the vector of data with the register file 224. Because most processor execution units include merge/rotate hardware, the techniques may use the merge/rotate hardware (e.g., the merge unit 218 and the rotation unit 220) to reduce latency and overhead (compared to using software) and to reduce cost and complexity (compared to adding alignment hardware in the memory subsystem 102).

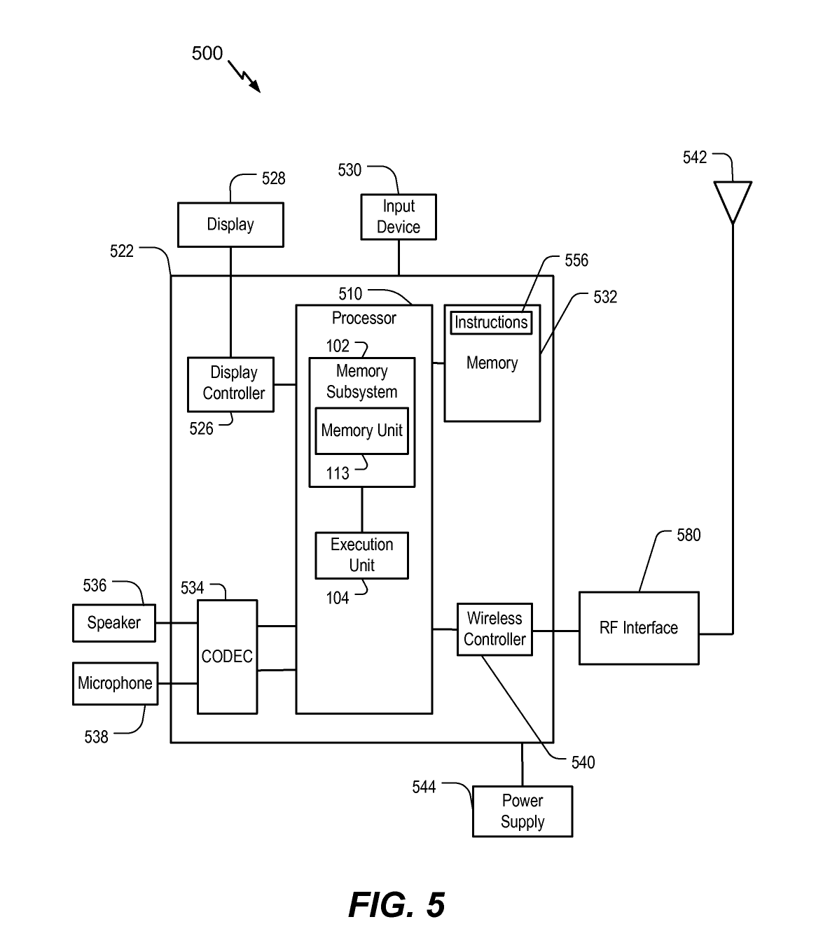

Referring to FIG. 5, a block diagram of a wireless device 500 is shown. The wireless device 500 includes execution hardware that is operable to align a vector of data for a load operation and/or a store operation. The wireless device 500 includes a processor 510, such as a digital signal processor (DSP), coupled to a memory 532.

FIG. 5 also shows a display controller 526 that is coupled to the processor 510 and to a display 528. A coder/decoder (CODEC) 534 can also be coupled to the processor 510. A speaker 536 and a microphone 538 can be coupled to the CODEC 534. FIG. 5 also indicates that a wireless controller 540 can be coupled to the processor 510 and to an antenna 542. A radio frequency (RF) interface 580 may be disposed between the wireless controller 540 and the antenna 542.

The processor 510 includes the memory subsystem 102 of FIGS. 1-2 and the execution unit 104 of FIGS. 1-2. Hardware in the execution unit 104 may function to align a vector of data for a load operation and/or to align a vector of data for a store operation, as described with respect to FIGS. 1-2. The memory 532 may be a tangible non-transitory processor-readable storage medium that includes executable instructions 556. The instructions 556 may be executed by a processor, such as the processor 510 (e.g., the execution unit 104), to perform the method 300 of FIG. 3 and/or the method 400 of FIG. 4. According to some implementations, portions of the memory subsystem 102 may also correspond to the memory 532. For example, the memory subsystem 102 may also include instructions that may be executed by the execution unit 104 to perform the methods 300, 400 of FIGS. 3-4.

In a particular embodiment, the processor 510, the display controller 526, the memory 532, the CODEC 534, and the wireless controller 540 are included in a system-in-package or system-on-chip device 522. In a particular embodiment, an input device 530 and a power supply 544 are coupled to the system-on-chip device 522. Moreover, in a particular embodiment, as illustrated in FIG. 5, the display 528, the input device 530, the speaker 536, the microphone 538, the antenna 542, and the power supply 544 are external to the system-on-chip device 522. However, each of the display 528, the input device 530, the speaker 536, the microphone 538, the antenna 542, and the power supply 544 can be coupled to a component of the system-on-chip device 522, such as an interface or a controller.

In conjunction with the described embodiments, an apparatus includes means for merging a first portion of a vector of data and a second portion of the vector of data to generate merged data. The first portion of the vector of data is stored in a first cache line of a cache and the second portion of the vector of data is stored in a second cache line of the cache. The vector of data corresponds to an unaligned memory address. For example, the means for means for merging the first portion of the vector of data and the second portion of the vector of data may include the merge unit 118 of FIG. 1, one or more other devices, circuits, modules, or any combination thereof.

The apparatus may also include means for rotating the merged data based on the unaligned memory address to generate rotated data. For example, the means for rotating the merged data may include the rotation unit 220 of FIG. 2, one or more other devices, modules, or any combination thereof.

The apparatus may also include means for storing the rotated data. For example, the means for storing the rotated data may include the temporary storage 222, the register file 224 of FIG. 2, one or more other devices, modules, or any combination thereof.

In conjunction with the described embodiments, a second apparatus includes means for modifying a first portion of a vector of data and a second portion of a vector of data to generate modified data. The vector of data is stored in a register file. For example, the means for modifying the first portion of the vector of data and the second portion of the vector data include the rotation unit 116 of FIG. 1, one or more other devices, modules, or any combination thereof.

That second apparatus also include means for generating first data and second data based on the modified data. The first data includes the first portion of the vector of data, and the second data includes the second portion of the vector of data. For example, the means for generating the first data and the second data include the separation unit 118 of FIG. 1, one or more other devices, modules, or any combination thereof.

The second apparatus also includes means for storing the first data and the second data. For example, the means for storing the first data and the second data may include the memory unit 113 of FIGS. 1-2, one or more other devices, modules, or any combination thereof.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

1. An apparatus comprising:
an execution unit configured to:
modify register aligned data having a first portion of a vector of data and a second portion of the vector of data to generate modified data, wherein the vector of data is stored in a register file prior to modification; and
generate first data and second data based on the modified data, wherein the first data includes the first portion of the vector of data, and wherein the second data includes the second portion of the vector of data; and
a memory unit that is operable to store the first data at a first portion of the memory unit and to store the second data at a second portion of the memory unit,
wherein, prior to modification., the register aligned data is unaligned with respect to the first portion of the memory unit and unaligned with respect to the second portion of the memory unit.

2. The apparatus of claim 1, wherein the memory unit includes a cache, wherein the first portion of the memory unit includes a first cache line of the cache, and wherein the second portion of the memory unit includes a second cache line of the cache.

3. The apparatus of claim 1, wherein an address of the first portion of the memory unit is adjacent to an address of the second portion of the memory unit.

4. The apparatus of claim 1, further comprising a memory subsystem that is operable to:
generate a first transaction to identify the first portion of the memory unit; and
generate a second transaction to identify the second portion of the memory unit, wherein the first transaction and the second transaction are generated based on a store instruction.

5. The apparatus of claim 1, wherein the execution unit is configured to separate the modified data to generate the first data and the second data.

6. The apparatus of claim 1, wherein the execution unit and the cache are integrated into a mobile phone.

7. The apparatus of claim 1, wherein the register aligned data is modified in response to an unaligned offset between the register aligned data prior to modification and the first data.

8. The apparatus of claim 1, wherein the register aligned data is modified based on a vector offset specified in lower bits of an unaligned store address.

9. The apparatus of claim 1, wherein a size of a vector register that stores the vector of data is equal to a size of the first portion of the memory unit.

10. The apparatus of claim 1, wherein a size of a vector register that stores the vector of data is smaller than a size of the first portion of the memory unit.

11. The apparatus of claim 1, wherein a size of a vector register that stores the vector of data is greater than a size of the first portion of the memory unit.

12. The apparatus of claim 1, wherein the execution unit is further configured to:
merge the first data and the second data to generate merged data;
modify the merged data based on an unaligned memory address to generate second modified data; and
store the second modified data in the register file.

13. A method comprising:
modifying, at an execution unit, register aligned data having a first portion of a vector of data and a second portion of the vector of data to generate modified data, wherein the vector of data is stored in a register file prior to modification;
generating first data and second data based on the modified data, wherein the first data includes the first portion of the vector of data, and wherein the second data includes the second portion of the vector of data;
storing the first data at a first portion of a memory unit; and
storing the second data at a second portion of the memory unit,
wherein, prior to modification, the register aligned data is unaligned with respect to the first portion of the memory unit and unaligned with respect to the second portion of the memory unit.

14. The method of claim 13, wherein the memory unit includes a cache, wherein the first portion of the memory unit includes a first cache line of the cache, and wherein the second portion of the memory unit includes a second cache line of the cache.

15. The method of claim 13, wherein an address of the first portion of the memory unit is adjacent to an address of the second portion of the memory unit.

16. The method of claim 13, further comprising:
generating a first transaction to identify the first portion of the memory unit; and
generating a second transaction to identify the second portion of the memory unit, wherein the first transaction and the second transaction are generated based on a store instruction.

17. The method of claim 13, wherein modifying the register aligned data includes rotating the register aligned data or performing a shift operation on the register aligned data.

18. The method of claim 13, further comprising:
merging the first data and the second data to generate merged data;
modifying the merged data based on an unaligned memory address to generate second modified data; and
storing the second modified data in the register file.

19. A non-transitory computer-readable medium comprising instructions that, when executed by an execution unit within a processor, cause the execution unit to:
modify register aligned data having a first portion of a vector of data and a second portion of the vector of data to generate modified data, wherein the vector of data is stored in a register file prior to modification;
generate first data and second data based on the modified data by separating the register aligned data prior to modification, wherein the first data includes the first portion of the vector of data, and wherein the second data includes the second portion of the vector of data;
store the first data at a first portion of a memory unit; and
store the second data at a second portion of the memory unit,
wherein, prior to modification, the register aligned data is unaligned with respect to the first portion of the memory unit and unaligned with respect to the second portion of the memory unit.

20. The non-transitory computer-readable medium of claim 19, the instructions, when executed by the execution unit, further cause the execution unit to:
merge the first data and the second data to generate merged data;
modify the merged data based on an unaligned memory address to generate second modified data; and
store the second modified data in the register file.
